(19) United States
(12) Patent Application Publication
(10) Pub. No.: US 2010/0136307 A1
(43) Pub. Date: Jun. 3, 2010

(54) Insulating Material

(75) Inventors: Friedrich Suchomel, Lenzing (AT); Johann Manner, Weyregg (AT); Heinrich Firgo, Vocklabruck (AT)

Correspondence Address: FITZPATRICK CELLA HARPER & SCINTO, 1290 Avenue of the Americas, NEW YORK, NY, 10104-3800, US

(73) Assignee: LENZING AKTIENGESELLSCHAFT, Lenzing (AT)

(21) Appl. No.: 12/446,647

(22) PCT Filed: Oct. 11, 2007
(86) PCT No.: PCT/AT2007/000477

§ 371 Date: Dec. 30, 2009

(30) Foreign Application Priority Data
Oct. 25, 2006 (AT) A 1801/2006

(51) Int. Cl. B32B 7/02; B32B 27/02; A47G 9/08; A47G 9/10; F16L 59/00

(52) U.S. Cl. 428/213; 428/218

(57) ABSTRACT

The invention relates to an insulating material which comprises a first layer of an essentially non-hygroscopic fiber material and a second layer of an essentially hygroscopic fiber material, said first layer being located adjacent said first zone and said second layer being located adjacent said second zone. The insulating material is characterized in that said first and said second layer are made of a highloft nonwoven material with a density of from 5 to 125 kg/m³.

### BACKGROUND OF THE INVENTION

### Field of the Invention

The present invention relates to an insulating material.

The term “insulating material” encompasses broadly all materials used to isolate a zone with a higher temperature from a zone with a lower temperature, such as especially filling material for duvets, pillows, sleeping bags, mattresses, filling materials for coating, such as for ski and winter wear; layers in sports clothing, or also thermal insulations in buildings and industrial applications.

Insulating materials commonly comprise a first surface and a second surface, said first surface, when in use, being in contact with a first zone having a first temperature and a first absolute humidity, and said second surface, when in use, being in contact with a second zone having a second temperature which is lower than the first temperature, and a second absolute humidity, which may be different from said first absolute humidity (especially if one thinks of bedding materials such as duvets).

It is known to produce insulating materials of the above-mentioned kind from bulky nonwoven articles, which are also called “highloft” nonwoven articles. Holiday, Th. M., “Highloft Nonwovens Handbook” INDA, 1989, generally describes the basic properties of highloft nonwoven articles useful also for insulation purposes.

As a “highloft” material, for the purposes of the present invention, one understands a material exhibiting a low density of typically from 5 to 25 kg/m³.

The properties of insulating materials with regard to the absorption of moisture are quite important. Especially, this holds true for bedding articles such as duvets, pillows and the like. When sleeping, the body sweats and the moisture thereby formed in the inner side of the duvet should be transported off through the duvet in vapour form. If, during the transport of the moisture, the temperature sinks below the dew point because of the existing difference between the temperature at the inner side of the duvet and the outside temperature, the moisture may condense. This results in a moist feeling of the duvet, which is highly undesirable.

The same principle holds, of course, true also for clothing articles in general, and, especially, for sportswear. Furthermore, condensation effects may also limit the efficiency of insulating materials in buildings or industrial applications.

Therefore, hygroscopic fibers, such as cellulose fibers, which are able to absorb moisture, are often used in insulating materials to avoid the negative effects of moisture condensation in the inside of said materials.

Furthermore, for various reasons it is known to use non-woven blends of non-hygroscopic fibers, such as Polyester fibers, and hygroscopic fibers, such as cellulose fibers, as filling materials, especially for bedding.

WO 99/16705, for example, discloses the use of a non-woven blend of Polyester fibers and Lyocell fibers as a filling material, for example for duvets and pillows. DE 44 45 085 A1 discloses the use of a non-woven blend of Polyester fibers and Ramie fibers for the same purpose. The use of a non-woven blend of Polyester fibers and Viscose fibers for the same purpose is known from EP 1 067 227.

Also the document “Processing trials with lyocell fibers using the stitch-bonding technique” by W. Fritsche in Melliand International (2) 1997, p. 80 ff., discloses nonwoven materials comprising Polyester and/or Lyocell fibers.

It is an object of the present invention to provide an insulating material wherein potential problems resulting of condensation effects in the inside of the material can be avoided or at least reduced, whilst on the other hand the breathability or ability of the material to transport off moisture stays essentially the same.

This object is solved by an insulating material comprising a first surface and a second surface, said first surface, when in use, being in contact with a first zone having a first temperature and a first absolute humidity, and said second surface, when in use, being in contact with a second zone having a second temperature which is lower than the first temperature and having a second absolute humidity which may be different from said first absolute humidity, said material comprising a first layer of an essentially non-hygroscopic fiber material and a second layer of an essentially hygroscopic fiber material, said first layer being located adjacent said first zone and said second layer being located adjacent said second zone, and which is characterized in that said first and said second layer are made of a nonwoven material with a density of from 5 to 125 kg/m³.

In a preferred embodiment, characterized in that the density of the nonwoven material is from 5 to 25 kg/m³, i.e. the nonwoven material is a highloft material.

Furthermore, a nonwoven material is preferred which has not been produced via a stitch-bonding process.

It has surprisingly been found that by employing at least two nonwoven fiber layers of hygroscopic respectively non-hygroscopic nature instead of an intimate mixture such as proposed in e.g. WO 99/17605, the effects of condensation in the inside of the material can be significantly reduced.

Especially, the insulating material of the present invention may exhibit a condensation zone in which zone, when in use, the temperature is below the dew point, and the thickness of said second layer of hygroscopic fibers may be selected so that said second layer at least extends over said condensation zone.

This means that the thickness of the fiber layers is selected such that the second layer of hygroscopic fibers extends into the zone where condensation of moisture is likely to occur due to the climatic difference between the two zones separated by the insulating materials when in use.

Based on the assumption that the temperature gradient between the first zone (having a higher temperature) and the second zone (having a lower temperature) separated by the material when in use, is linear, one can determine the expected condensation zone, i.e. the zone in which condensation is likely to occur, based on the climatic properties (such as temperature and absolute humidity) of the two zones, by way of applying a psychrometric or Mollier chart.

In the case of a duvet, for example, the first zone adjacent to the sleeping body may be assumed to have an average temperature of around 30° C. to 35° C., with an absolute humidity of around 15 g H₂O/m³ air. The second zone, at the outside of the duvet, may have a room climate with temperatures ranging from 15° C. to 10° C. and around 8 g H₂O/m³ air.

Taking into consideration a duvet with a filling material having a certain thickness, such as e.g. 4 cm, one can determine on the base of the above data, using a Mollier chart, the zone where condensation is likely to occur when the duvet is used.

According to the present invention, the proportion of the thickness of the second (hygroscopic) layer in relation to the overall thickness of the insulating material is then chosen such that, when in use, the hygroscopic layer at least extends over said condensation zone.

In further preferred embodiments, it is possible to define a preferred proportion of the second (hygroscopic) layer in relation to the overall thickness of the insulating material depending on the expected temperature difference between the first and the second zone separated by the material when in use.

Therefore, according to a preferred embodiment of the present invention, the portion y of the thickness of said second layer related to the total thickness of the material fulfils the following formulas:

y (%)>0 and

y (%)≧207.89-514.84x^{-0.333},

wherein x denotes the difference between said first temperature of the first zone and said second temperature of the second zone, and wherein x ranges from 5 to 80° C.

This range of portions y of the second (hygroscopic) layer will especially be suitable in the case of insulating materials being selected from the group consisting of filling materials for duvets, pillows, sleeping bags, mattresses, quilts and sleepwear.

These materials have in common that they are mostly used during sleeping, where the human body has low activity and, consequently, sweats less, resulting in an absolute humidity in the zone surrounding the body of around 15 g H₂O/m³.

If the portion y of the hygroscopic fiber layer in an article according to the invention is selected such that it fits within the above-mentioned formulae, the hygroscopic fiber layer will extend over the expected condensation zone within the article, whereby moisture formed in that zone during use will be absorbed by the hygroscopic fibers.

In another preferred material according to the present invention, said portion y fulfils the following formula:

y (%)≧140.88-451.25x^{-0.5}.

This range of portions y of the second (hygroscopic) layer will especially be suitable in the case of insulating materials being selected from the group consisting of filling materials for everyday's clothing.

Under “everyday's clothing”, clothing that is normally worn during the day, as opposed to sportswear, is meant. Examples for everyday's clothing are shirts, trousers, blouses, jackets and the like for everyday's use.

In the field of everyday's clothing which is worn during the day, an absolute humidity of around 20 g H₂O/m³ is expected to be present in the zone surrounding the body, due to the higher activity of the body as compared with the activity when sleeping.

If the portion y is selected so that it fits within the above-mentioned formula, the hygroscopic fiber layer will extend over the condensation zone which is likely to occur when the clothing is in daily use.

Finally, in a further preferred embodiment, the insulating material according to the invention is characterized in that said portion y fulfils the following formula:

y (%)≧100.34-504.27x⁻¹.

This range of portions y of the second (hygroscopic) layer will especially be suitable in the case of insulating materials being selected from the group consisting of sportswear.

When practicing sports, the human body exerts a high activity, resulting in a higher relative humidity surrounding the body, assumed to be around 30 g H₂O/m³. Therefore, the portion y of the second (hygroscopic) layer in, e.g., sportswear must be higher than that in a sleeping article or everyday's clothing. The above-mentioned formula defines the suitable range of portion y, again depending on the temperature difference between the first and the second zone separated by the insulating material when in use.

The first (non-hygroscopic) layer of the material according to the invention may preferably comprise a fiber material selected from the group consisting of Polyester fiber, glass fiber, mineral rock fiber, Polypropylene fiber, Polyamide fiber, Polyacrylonitrile fiber, Polylactic acid fiber, Polyethylene fiber and mixtures thereof.

The second (hygroscopic) layer of the material according to the invention may preferably comprise a fiber material selected from the group consisting of cotton, ramie, Viscose fiber, Modal fiber, Lyocell fiber, linen, hemp, Kapok, wool, feathers, down, poplar seed hair and mixtures thereof.

Both the first and the second layer may also comprise mixtures of both hygroscopic and non-hygroscopic fibers, respectively, as long as the overall hygroscopic respectively non-hygroscopic nature of the respective layer is retained.

Furthermore, the material of the present invention may comprise more than two layers, such as one or more additional fiber layers, or cover sheets, as long as the thickness of the hygroscopic layer is selected such that it extends over the condensation zone of the material.

The layers of the material of the present invention may be connected to each other by processes known per se in the art, such as by arranging the layers over each other and attaching them together and/or to an outside fabric layer in a known manner.

Both the essentially hygroscopic fiber material and the essentially non-hygroscopic fiber material may comprise modified fiber materials, such as fibers modified in order to possess flame-retardant properties and the like.

The present invention also relates to the use of an insulation material according to the present invention as a filling material for duvets, pillows, sleeping bags, mattresses; as a filling material for clothing, such as for ski and winter wear; as a layer in sports clothing, or as a thermal insulation in buildings (such as for brickwork, roof insulation or window frames) and industrial applications (such as for heating or cooling devices, air conditioning devices, pipework, transportation means, e.g. airplanes, cars and trains).

A preferred embodiment of the insulating material according to the present invention is selected from the group consisting of filling materials for duvets, pillows, sleeping bags, mattresses, quilts and sleepwear, and is characterized in that the portion y of the thickness of said second layer related to the total thickness of the material is 20% or more, preferably 20% to 50%. This range of portion y will cover most materials wherein the activity of the body is low and the temperature difference between the zone surrounding the body and the zone outside the material is from about 20° C. to 35° C.

A further preferred embodiment of the insulating material according to the present invention is selected from the group consisting of sleeping bags, and is characterized in that the portion y of the thickness of said second layer related to the total thickness of the material is 40% or more, preferably 50% to 90%. This range of portion y will especially cover sleeping bags suitable even for very low temperatures, where the temperature difference between the zone surrounding the body and the zone outside the material may be as high as 35° C. to 80° C.

A further preferred embodiment of the insulating material according to the present invention is selected from the group consisting of ski and winter wear, especially winter coats, winter trousers, anoraks, winter jackets and high altitude climbing wear, and is characterized in that the portion y of the thickness of said second layer related to the total thickness of the material is 60% or more, preferably 75% to 85%. This range of portion y will cover most materials suitable for use even at low temperatures, with medium to high activity of the body, and the temperature difference between the zone surrounding the body and the zone outside the material ranging up to about 30° C. to 70° C.

Finally, a further preferred embodiment of the insulating material according to the present invention selected from the group consisting of sportswear, and is characterized in that the portion y of the thickness of said second layer related to the total thickness of the material is 70% or more, preferably 80% to 95%. This range of portion y will cover most sportswear applications, with high activity of the body, and the temperature difference between the zone surrounding the body and the zone outside the material ranging from about 20° C. to 60° C. or even more.

The present invention will now be described in more detail by way of the figures and the examples.

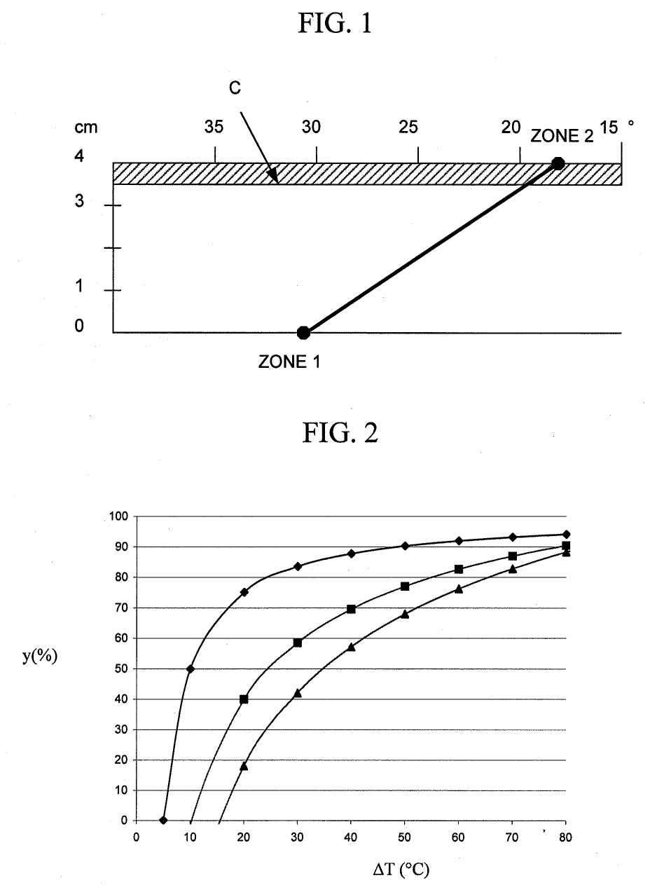

Thereby, FIG. 1 shows schematically the temperature gradient in a duvet.

FIG. 2 shows the curves for suitable ranges of the portion y of the thickness of the hygroscopic fiber layer related to the total thickness of the material according to the invention, depending on the application area (body activity) and the temperature difference between the first zone (surrounding the body) and the second zone.

According to FIG. 1, a duvet with a filling of 100% Polyester fiber may exhibit a typical thickness of 4 cm. When in use, the duvet will separate two zones, indicated in FIG. 1 as “ZONE 1” and “ZONE 2”.

ZONE 1, the sleeping zone, is the zone where the sleeping body is in contact with the first surface of the duvet. In the example according to FIG. 1, the temperature in this zone is 30.7° C., and the absolute humidity is 14.5 g H₂O/m³ air.

ZONE 2 is the air at the outer side of the duvet. In the example according to FIG. 1, the climate of this zone is a room climate with 18° C. and 7.7 g H₂O/m³ air.

Based on the assumption that the temperature gradient between ZONE 1 and the ZONE 2 is linear, one can determine the expected condensation zone, i.e. the zone in which condensation is likely to occur, based on the given climatic properties (such as temperature and absolute humidity) by way of applying a psychrometric or Mollier chart.

Thus, it is shown that in the duvet according to FIG. 1, given the climatic properties of ZONE 1 and ZONE 2, at a distance of about 3.5 cm away from the surface adjacent to the sleeping body, the temperature will be below the dew point, whereby a zone is formed wherein condensation may occur (the hatched zone denoted with “C”).

If, according to the preferred embodiment of the present invention, the duvet filling consists of two layers, one layer made of 100% Polyester fiber and being located adjacent ZONE 1, and the second layer made of 100% Lyocell fiber and being located adjacent ZONE 2, and if the thickness of said second layer extends at least over said condensation zone C, then water that is condensed in said zone will be absorbed by the hygroscopic Lyocell fibers, and the formation of moisture in the duvet filling can be avoided.

FIG. 2 demonstrates the preferred ranges of the portion y of the thickness of the second layer of essentially hygroscopic fiber material according to the present invention.

The abscissa in FIG. 2 denotes the difference in temperature (ΔT in ° C.) between the first zone and the second zone which are separated by the insulating material, such as the skin of the human body and the outside climate in the case of clothing.

The ordinate denotes the portion y (%) of the thickness of the layer of hygroscopic fiber material.

Depending on the amount of body activity involved when using the insulating material, three preferred ranges can be identified:

If the activity of the human body is very high, such as when practicing sports, then the body will sweat, resulting in a high absolute humidity at the body-adjacent side of the insulating material of around 30 g H₂O/m³. In this case, depending on the difference between the temperature at the body-adjacent side (which may be around 30-35° C.) and the outside temperature (which may be less than 0° C.), the portion y of the thickness of the hygroscopic layer should be at least as high as the value defined by the left-most curve shown in FIG. 2 (-♦-♦-♦-♦-), which can be fitted by the equation y (%)≧100.34-504.27x⁻¹.

If the insulating material is to be used in situations of medium body activity, such as in everyday's clothing, resulting in a medium absolute humidity at the body-adjacent side of the insulating material of around 20 g H₂O/m³, it is found that the portion y of the thickness of the hygroscopic layer should be at least as high as the value defined by the curve in the middle of the three curves in FIG. 2 (-▪-▪-▪-▪-), which can be fitted by the equation y (%)≧140.88-451.25x^{0.5}.

Finally in applications with a low body activity, such as in bedding articles, where the absolute humidity at the body-adjacent side of the insulating material may be around only 15 g H₂O/m³, it is found that the portion y of the thickness of the hygroscopic layer should be at least as high as the value defined by the right-most curve in FIG. 2 (-▴-▴-▴-▴-), which can be fitted by the equation y (%)≧207.89-514.84x^{-0.333}.

The single points defining the three curves were each determined by investigating, based on the humidity and temperature conditions given and based on a linear temperature gradient within the material, the distance from the body-adjacent surface of the insulating material where the temperature reaches a value lower than the respective dew point, on the basis of a common psychrometric/Mollier chart.

What is claimed is:

1. An insulating material comprising a first surface and a second surface, said first surface, when in use, being in contact with a first zone having a first temperature and a first absolute humidity, and said second surface, when in use, being in contact with a second zone having a second temperature which is lower than the first temperature and having a second absolute humidity which may be different from said first absolute humidity, said material comprising a first layer of an essentially non-hygroscopic fiber material and a second layer of an essentially hygroscopic fiber material, said first layer being located adjacent said first zone and said second layer being located adjacent said second zone, characterized in that said first and said second layer are made of a nonwoven material with a density of from 5 to 125 kg/m³.

2. The insulating material according to claim 1, wherein the density of the nonwoven material is from 5 to 25 kg/m³.

3. The insulating material according to claim 1, wherein said material exhibits a condensation zone in which zone, when in use, the temperature is below the dew point, and that the thickness of said second layer is selected so that said second layer at least extends over said condensation zone.

4. The insulating material according to any of claims 1 to 3, wherein the portion y of the thickness of said second layer related to the total thickness of the material fulfils the following formulas:
y (%)≧0 and
y (%)≧207.89-514.84x^{-0.333},
wherein x denotes the difference between said first temperature and said second temperature, and wherein x ranges from 5 to 80° C.

5. The insulating material according to claim 3 or 4, wherein said insulating material is selected from the group consisting of filling materials for duvets, pillows, sleeping bags, mattresses, quilts and sleepwear.

6. The insulating material according to claim 4, wherein said portion y fulfills the following formula:
y (%)≧140.88-451.25x^{-0.5}.

7. The insulating material according to claim 6, being selected from the group consisting of filling materials for everyday's clothing.

8. The insulating material according to claim 4, wherein said portion y fulfills the following formula:
y (%)≧100.34-504.27x⁻¹.

9. The insulating material according to claim 8, wherein said insulating material is selected from the group consisting of sportswear.

10. The insulating material according to claim 1, wherein said first layer comprises a fiber material selected from the group consisting of Polyester fiber, glass fiber, mineral rock fiber, Polypropylene fiber, Polyamide fiber, Polyacrylonitrile fiber, Polylactic acid fiber, Polyethylene fiber and mixtures thereof.

11. The insulating material according to claim 1, wherein said second layer comprises a fiber material selected from the group consisting of cotton, ramie, Viscose fiber, Modal fiber, Lyocell fiber, linen, hemp, Kapok, wool, feathers, down, poplar seed hair and mixtures thereof.

12. The insulting material according to any of claims 1 to 3, wherein said insulating material is a filling material for duvets, pillows, sleeping bags, mattresses; quilts, as a filling material for clothing, such as for ski and winter wear; as a layer in sports clothing, or as a thermal insulation in buildings, such as for brickwork, roof insulation or window frames, and industrial applications, such as for heating or cooling devices, air conditioning devices, pipework, transportation means, e.g. airplanes, cars and trains.

13. The insulating material according to any one of claims 1 to 3, wherein said insulting material is being selected from the group consisting of filling materials for duvets, pillows, sleeping bags, mattresses, quilts and sleepwear, characterized in that the portion y of the thickness of said second layer related to the total thickness of the material is 20% or more, preferably 20% to 50%.

14. The insulating material according to any one of claims 1 to 3, wherein the insulating material is selected from the group consisting of sleeping bags, characterized in that the portion y of the thickness of said second layer related to the total thickness of the material is 40% or more, preferably 50% to 90%.

15. The insulating material according to any one of claims 1 to 3, wherein the insulating material is selected from the group consisting of ski and winter wear, especially winter coats, winter trousers, anoraks, winter jackets and high altitude climbing wear, characterized in that the portion y of the thickness of said second layer related to the total thickness of the material is 60% or more, preferably 75% to 85%.

16. The insulating material according to any one of claims 1 to 3, wherein the insulating material is selected from the group consisting of sportswear, characterized in that the portion y of the thickness of said second layer related to the total thickness of the material is 70% or more, preferably 80% to 95%.
